(19) United States
(12) Patent Application Publication
(10) Pub. No.: US 2017/0033712 A1
(43) Pub. Date: Feb. 2, 2017

(54) Motor powered by electrostatic forces

(71) Applicant: Nathanial Henry Lewis, Fallon, NV (US)

(72) Inventor: Nathanial Henry Lewis, Fallon, NV (US)

(21) Appl. No.: 14/756,089

(22) Filed: Jul. 31, 2015

(51) Int. Cl. H02N 1/00

(52) U.S. Cl. CPC H02N 1/002

(57) ABSTRACT

An electrostatic repulsion motor comprising a rotor adjacent a stator. A main charging line is connected to a rotor charging line and a stator charging line. There is a discharging for the rotor. A continuous repeating of the charging and discharging sequences, produces continuous rotation of the rotor. Mechanical energy is generated at the axle of the rotor by the electrostatic energy going into the motor. Electrostatic energy in a concentrated amount is the second most powerful type of energy, nuclear energy being the first. The problems for the need of better insulating materials and techniques have gone away, along with the economical and convenient shortcomings. An important property of the electrostatic motor is that they can operate from a much greater variety of sources than the present electromagnetic motors. The electric field of the earth is one example.

### BACKGROUND OF THE INVENTION

Field of the Invention

Electromagnetic motors are of the alternating current (AC) and direct current (DC) types; they develop mechanical force through the interaction of magnetic fields that are generated with high electric current at low voltage, as Michael Faraday demonstrated in 1821. Electrostatic motors are similar in principle to the motor invented by Benjamin Franklin in 1748. These motors develop mechanical force through electrostatic forces between electric charges that are generated by relatively low direct current (DC) at high voltage.

Description of the Related Art

Benjamin Franklin left no drawing of his motor; he did describe it to a friend in a letter. Working models have been reconstructed; useful mechanical forces have been low. He was the first person who designed and built electrostatic motors of appreciable power, about o.1 watt.

Electrostatic motors are based on the force of mutual attraction between unlike charges and the mutual repulsion of like charges. Electrostatic motors have been operated from voltage in excess of 10⁵ volts. They have been operated by using currents smaller than 10⁻⁹ ampere. In nature the electrostatic forces are much stronger than the magnetic ones. Finally, an important property of the electrostatic motor is that they can operate from a much greater variety of sources than the electromagnetic motors. Interesting sources of electricity for electrostatic motors are the ordinary capacitor and the electric field of the earth.

The classification of electrostatic motors is in general by the method by which charge is either stored in the motor or transferred to the rotor. There are the contact motors, spark motors, corona motors, induction motors, electret motors, liquid- or gas-immersed motors, dielectric motors, and conduction-plates or capacitor motors. The corona type of electrostatic motor requires no brushes or commutators. However, a limiting factor of the corona motor is its required minimum potential of 2,000 volts. Nevertheless, this one is considered the best.

### BRIEF SUMMARY OF THE INVENTION

The basic nature of the science of electrostatic is the study of electric charges at rest relative to one another; not in motion, as in electric currents. Electrostatic motors are extremely simple in design and require no expensive materials. Having only a few metal parts they possess a very good power-to-weight ratio. They can attain very high speeds; they have been built with speeds from 1000 rpm to 6000 rpm. However, these motors bearings have to be a very low friction. They have reached an appreciable amount of power; one was six watts.

This ELECTROSTATIC REPULSION MOTOR will go far beyond other electrostatic motors in performances. Electrostatic energy in a concentrated amount is the second most powerful type of energy, nuclear energy being first. An example would be lightning caused by electrostatic energy built up between the many large positive and negative charges inside clouds.

### BRIEF DESCRIPTION OF THE DRAWINGS

FIG. 1A to 1D are symbolic presentations of the physics of electrostatic energy.

FIG. 2 is a side view of an ELECTROSTATIC REPULSION MOTOR.

FIG. 3 is a partial side view of the motor and the entire stator is shown section.

FIG. 4 is a front view of the motor.

FIG. 5 is a partial section view of a charging assembly or a discharging assembly for the rotor of the motor.

FIG. 6 is a side view of a typical rotor hole with a plurality of fine wires.

FIG. 7 is a top view of an electrical insulating cover cap, connected to an electric line.

FIG. 8 is a side view of the electrical insulating cover cap, connected to an electric line.

FIG. 9 is a bottom view of the electrical insulating cover cap showing its plurality of fine wires.

FIG. 10 is a side view of the rotor with its axle.

FIG. 11 is a partial front view of the rotor and its axle.

FIG. 12 is a side view of the stator.

FIG. 13 is an upper section view of FIG. 12.

FIG. 14 is a lower section view of FIG. 12.

### DETAILED DESCRIPTIONS

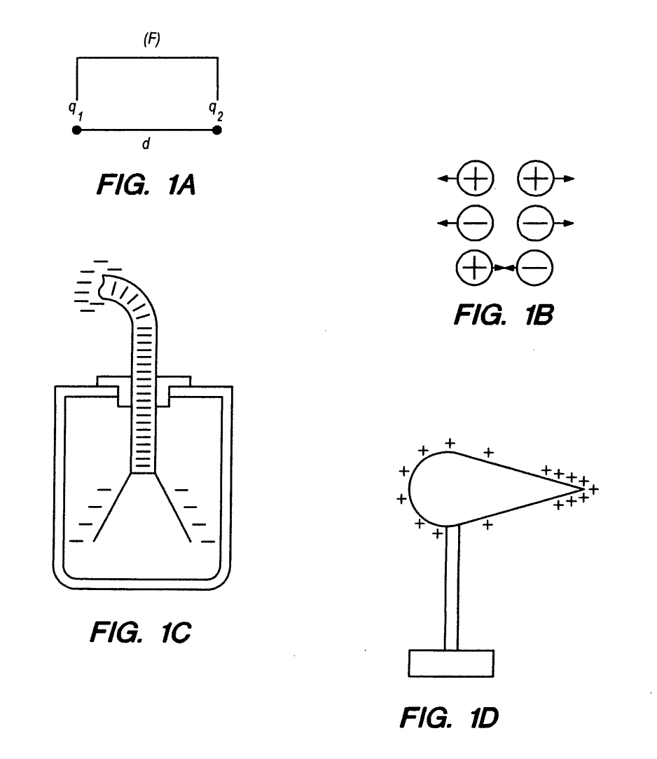

An appropriate starting point in the science of electrostatics is Coulomb's law. See FIG. 1A. The force (F) exerted on one point charge (q) by another point charge (q) is proportional to the magnitude of the charges (q q), and inversely proportional to the square of the distance (d) between the charges, and has a direction along the line joining the two charges.

In FIG. 1B, it is repulsive if the charges have the same-signs (+ or −) and attractive force if the charges are opposite in signs (+ and −). All mediums other than a vacuum act to reduce the force (F), however the difference between air and a vacuum in the above relationship is negligible.

The electroscope in FIG. 1C shows repulsion between two objects that have been charged with like charges. The pointed object in FIG. 1D is charged positive; a positive charge is created by an absence of electrons. If a conductor is made positive, electrons in the vicinity of the point are accelerated toward the point, unlike charges attract.

The electron is considered to be the smallest fundamental particle and the only one that has a negative charge. Its value is very, very tiny in the Coulomb unit. A proton has a mass that is 1837 times the electron. However, the proton has a positive charge that is the same value as the electron. The electron is very mobile; it can move from place to place.

Where the radius of curvature of a conductor is very small, very high electric field intensity is possible in a small region. A high field strength gives rise to a discharge called corona. Corona is common when pointed conductors or fine wires are used as electrodes. A sharp-pointed conductor which is maintained at high negative potentials (excess electrons) will give rise to a corona discharge.

Either positive charges or negative charges can be used in this ELECTROSTATIC REPULSION MOTOR. However, negative charges—excess electrons—would be more advantageous judging from certain electrostatic properties.

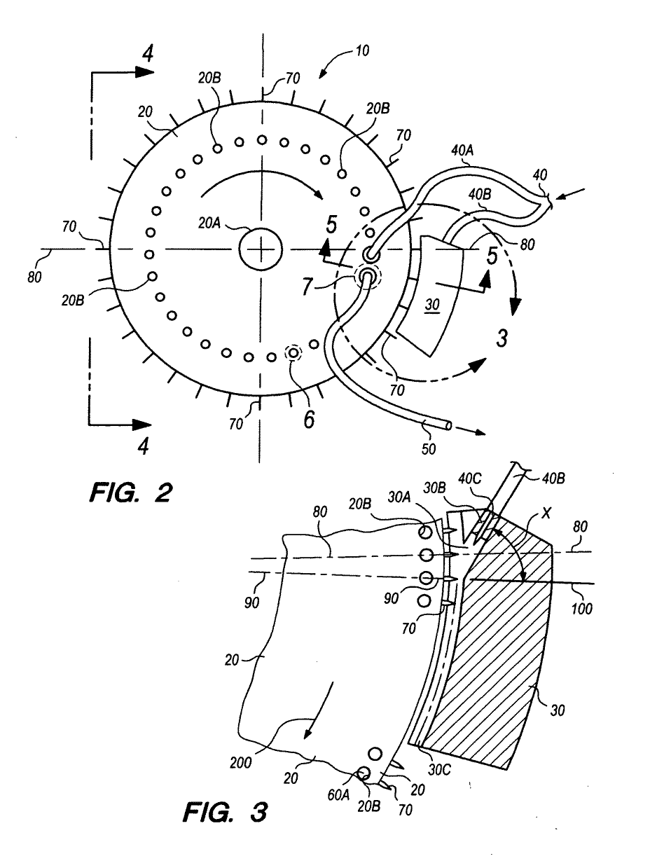

Refer to FIG. 2. The electrostatic repulsion motor 10 comprises a rotor 20 adjacent a stator 30. The curvature of the rim of the rotor 20 matches the curvature of the inner surface of the stator 30. The rotor 20 comprises an axle 20A and a plurality of equally spaced side holes 20B on one side near its rim. There is a plurality of pointed metallic prongs 70 protruding from its equally spaced rim holes.

A main charging line 40 is connected to a rotor charging line 40A and a stator charging line 40B; they are in electrical parallel. There is a discharging line 50 also. The center line 80 is for alignment purposes. The rotor 20 and stator 30 should be made from a material that is strong, tough, and with good electrical insulation properties.

Refer to FIG. 3. The rotor 20 has a plurality of side holes 20B, each contain fine wires 60A connected to a pointed metallic prong 70. The stator 30 has a centered round hole 30A that makes an angle X with a horizontal line 100; the greater the angle X the better. An assembly comprising a stabilizing round plug 30B holding a pointed metallic prong, 40C which is connected to the stator charging line 40B; it is above the round hole 30A.

When a pointed metallic prong 70 of the rotor 20 is in alignment with the horizontal center line 80, and opposite the pointed metallic prong 40C of the stator 30, and both charged with like charges simultaneously—a repulsive force—this will cause rotation 200 on the rotor 20.

When the pointed metallic prong 70 reaches the lower line 90 it will discharge. The continuous repeating of the above sequence for each prong 70 around the rim of the rotor 20, produces continuous rotation 200 of the rotor 20. The many pointed metallic prongs 70 passes through the v-shape groove 30C centered in the stator 30. The v-shape groove 30C intersect the round hole 30A.

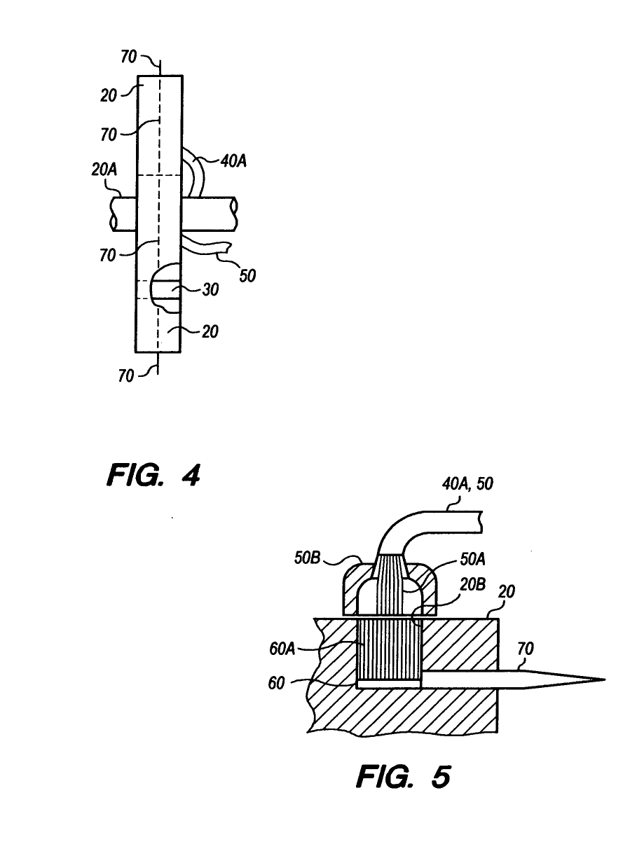

Refer to FIG. 4, a front view. The rotor 20 and stator 30 of the motor 10 can have equal width. The prongs 70, rotor charging line 40A and rotor discharging line 50 are shown. The bearings which the axle 20A rests on have to be at very low friction. Mechanical energy is generated at the axle 20A by the inner electrostatic energy.

Refer to FIG. 5. This is a detailed view of an assembly that can be used to charge a pointed metallic prong 70 in the rotor 20, or discharge it 70. The charging line 40A and the discharging line 50 each has an electrical insulation cover cap 50B. The cap 50B has fine wires 50A therein, it 50B is placed near the rotor 20. And the cap 50B is in alignment with a side hole 20B near the rim of the rotor 20.

For charging, the charges travel from the upper fine wires 50A to the lower fine wires 60A and its metallic cylindrical base 60 then to the prong 70. For discharging, the charges travel in a reverse path from the prong 70.

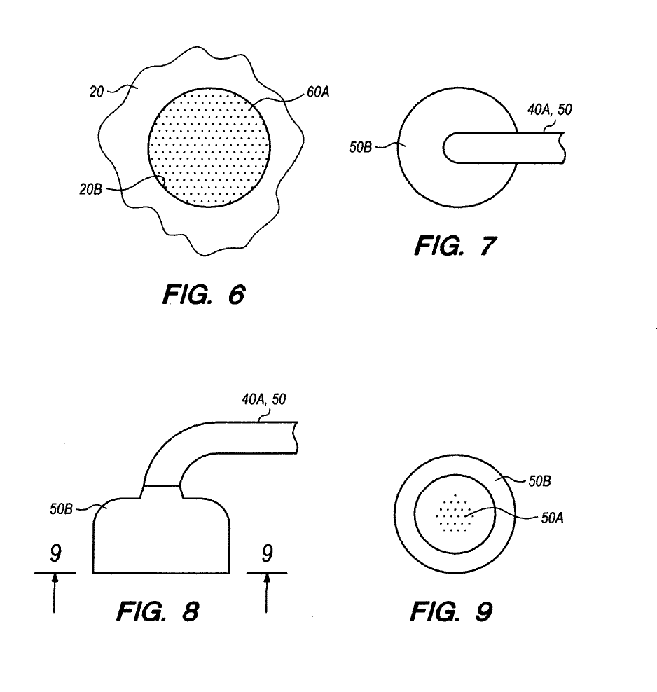

Refer to FIG. 6. The hole 20B in the side of the rotor 20 comprising fine wires 60A, can be covered by the cover cap 50B of FIG. 7. The line 40A, 50 can be for charging or discharging, respectively. Refer to FIG. 8. The cover cap 50B and its line 40A, 50 have a bottom view. The cover cap 50B is housing fine wires 50A in FIG. 9.

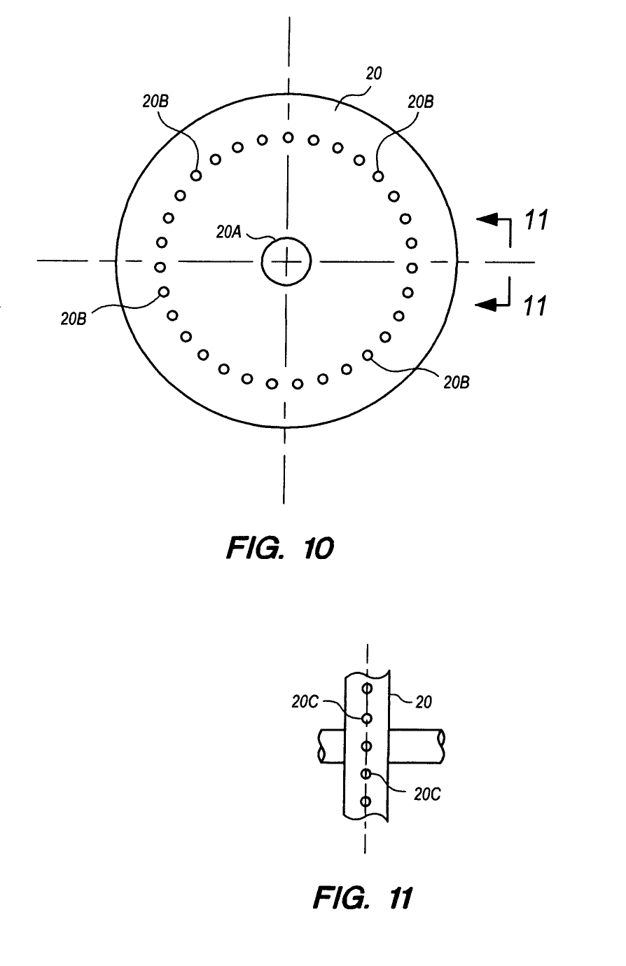

Refer to FIG. 10. The rotor 20 with its axle 20A and a plurality of side holes 20B are shown. FIG. 11 shows a plurality of centered, round rim holes 20C around the rim of the rotor 20; these are for the protruding prongs. Each side hole 20B is equally spaced and connected to a rim hole 20C on the rim.

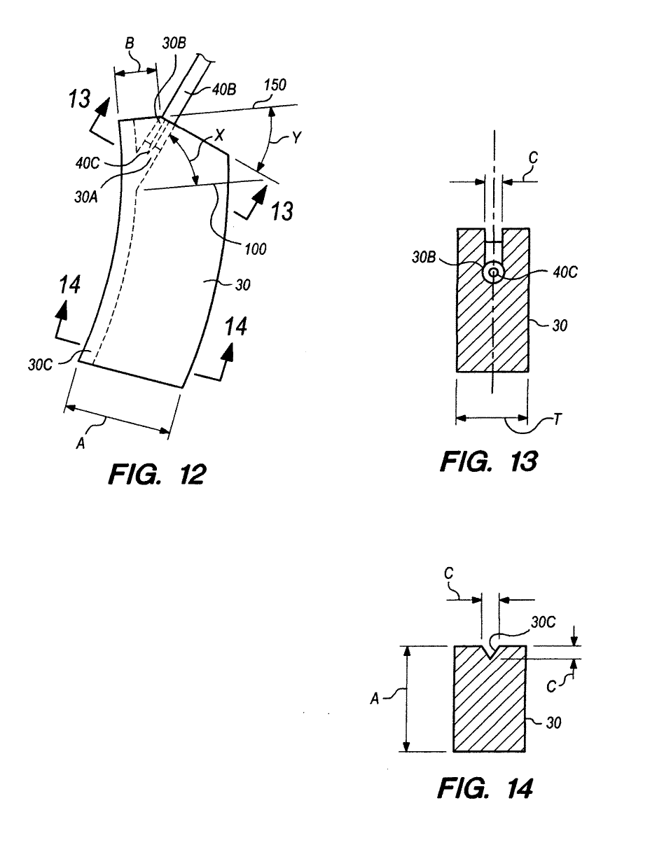

Refer to FIG. 12. The assembly of the stator charging line 40B and its pointed metallic prong 40C is centered and inserted into the stabilizing round plug 30B. The plug 30B is inserted into the upper of the centered round hole 30A. The lower part of this hole 30A acts like an inner chamber for the concentrated electrostatic energy. The stator 30 has a v-shape groove 30C.

For the proper operation of the motor, the important dimensions A and B and important angles X and Y, are needed to show the correct configurations the stator 30 needs. The exact dimensions A and B vary with the size of the stator 30, but the angles X and Y can remain the same. The two lines 100 and 150 are parallel.

Refer to FIG. 13. This section view reveals the stabilizing round plug 30B and its pointed metallic prong 40C, and an important dimension C for the stator 30. The thickness T of the stator 30 can vary with the size of the motor. Refer to FIG. 14. This section view reveals the v-shape groove 30C of the stator 30, and two important dimensions A and C are shown as well.

Why is most motors the electromagnetic type (called the electric motor by many), and using “inferior” magnetic forces? There are two main reasons. First, any useful concentrations of electrostatic charges can cause an electric breakdown in the medium surrounding or supporting the charges. Second, very, very high voltages are needed for electrostatic motors. The “problems” for the need of better insulating materials and techniques have vanished, along with the economical and convenient shortcomings.

The future looks very, very good for the electrostatic motor. Direct currents at very, very high voltages are transported more efficiently than alternating currents. The electromagnetic motor—known mostly as the electric motor—will always remain very important too.

I claim:

1) An electrostatic motor comprising a rotor and a stator and having charging and discharging lines, wherein:
a) said rotor with an axle and a plurality of side holes;
b) there is a plurality of rim holes;
c) there is a plurality of pointed metallic prongs protruding from said rotor;
d) each said side holes have fine wires connected to each said pointed metallic prong;
e) said stator has a v-shaped groove;
f) said v-shaped groove meets a round hole;
g) said round hole makes an angle;
h) therein said round hole is a plug holding a pointed metallic prong;
i) said pointed metallic prong in said stator is opposite a said pointed metallic prong in said rotor;
j) a charging line is connected to said charging lines of said rotor and said stator;
k) said rotor charging line has a cover cap with fine wires therein;
l) said rotor discharging line has a cover cap with fine wires therein, and
m) whereby the rotating axle of said rotor is generated by the charging and discharging of said motor.

2) An electrostatic motor comprising a rotor and a stator and having charging and discharging lines, wherein side holes as claimed in claim 1, said side holes are many.

3) An electrostatic motor comprising a rotor and a stator and having charging and discharging lines, wherein rim holes as claimed in claim 1, said rim holes are many.
